(19) United States
(12) Patent Application Publication
(10) Pub. No.: US 2006/0207814 A1
(43) Pub. Date: Sep. 21, 2006

(54) Electric wheel

(76) Inventor: Sin-Dun Tseng, Hsientien City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/083,608

(22) Filed: Mar. 18, 2005

(51) Int. Cl. B60K 1/00

(52) U.S. Cl. 180/65.5

(57) ABSTRACT

An electric wheel has a transmission assembly and wheel speed detecting device mounted inside a chamber formed by two assembled sidewalls. A rubber tire surrounds the peripheries of the assembled sidewalls. Two hollow forks are respectively attached to external surfaces of the two sidewalls. A transmission ring is formed on an inner surface of one of the sidewalls and driven by the transmission assembly to rotate. As a result, the electric wheel is driven by the transmission ring and has rotating movements.

### BACKGROUND OF THE INVENTION

1. Field of the invention

The invention relates to an electric wheel, and more particularly to a wheel suitable for use in light-duty devices, wherein motors are mounted inside the wheel as a power source to drive the wheel.

2. Related Art

Varied useful means of transportation have been widely used and accepted in daily life. For example, supermarket trolleys, buggies, scooters or golf-bag trolleys are quite familiar to most people.

Wheels are the most used elements in these transportation means and are usually driven by gears or belts fitted to an external transmission mechanism. However, high precision in alignment among different components required by the external transmission design is necessary. Further, using the external transmission mechanism may cause annoying noise and also leads the volume of the entire device to become unsatisfactorily bulky.

For the above reasons, a novel electric wheel is proposed to overcome the shortcoming of the prior arts.

### SUMMARY OF THE INVENTION

An objective of the present invention is to provide an electric wheel of which the rotation speed can be easily adjusted by software without need of a high precision speed-changing mechanism so as to effectively mitigate unwanted noise.

To achieve the objective, the electric wheel provides two sidewalls assembled together to retain a transmission assembly therein, wherein a transmission ring is formed on an inner surface of one sidewall and is driven by the transmission assembly to rotate; a rubber tire surrounds peripheries of the two assembled sidewalls; and a fork assembly has two hollow forks that are respectively attached to external surfaces of the two sidewalls.

Further advantages, features and details of the present invention will be elucidated on the basis of the following description of a preferred embodiment thereof, with reference to the annexed figure showing a circuit diagram thereof.

### BRIEF DESCRIPTION OF THE DRAWINGS

FIG. 1 is an exploded perspective view of an electrical wheel of the present invention.

FIG. 2 is a perspective view showing internal components of the electrical wheel.

FIG. 3 is a perspective view of the electrical wheel.

FIG. 4 is a circuit block diagram of the present invention applied to control the electrical wheel.

FIG. 5 shows an explanatory waveform according to the control theory of phase integration-differential used in the present invention.

FIG. 6 shows another explanatory waveform according to the control theory of phase integral differential (PID) used in the present invention.

FIG. 7 is an explanatory waveform of the PWM control theory applied in the present invention.

FIG. 8 is an explanatory waveform of the conventional power control.

### DETAILED DESCRIPTION OF THE PREFERRED EMBODIMENT

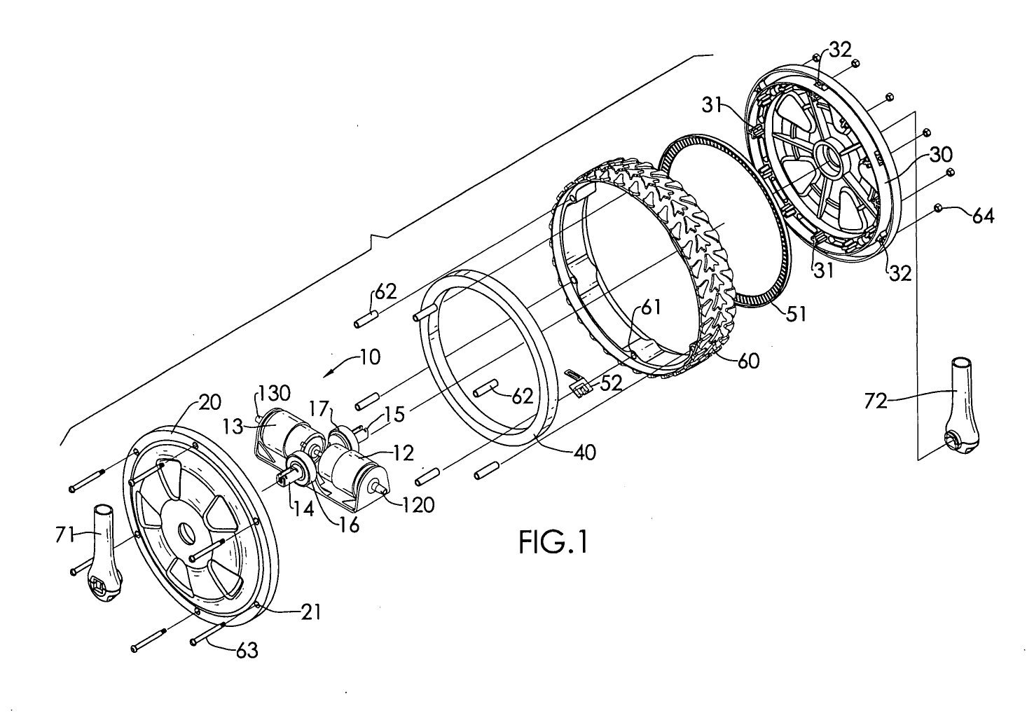

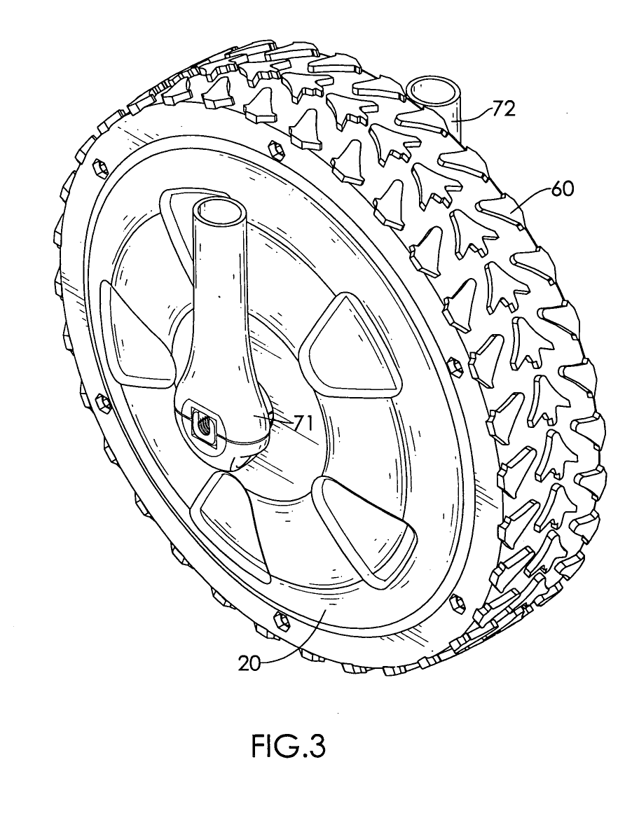

With reference to FIGS. 1 to 3, an electric wheel of the present invention mainly includes a transmission assembly (10), a left sidewall (20), a right sidewall (30), a wheel speed detecting device, a rubber tire (60) and a fork assembly.

The transmission assembly (10) includes a pair of motors (12)(13) mounted on a U-shaped base (11). The base (11) can be preferably made by a high-pressure extrusion or die casting process to form a bottom board, two upright walls extending from opposite ends of the bottom board, and two ears each of which projecting from the middle position at an edge of the bottom board. The motors (12)(13) are arranged in alignment with each other on the base (11) but rotate in opposite directions. Each motor (12)(13) has a spindle enclosed and protected by a spindle sleeve (120)(130) that projects through the upright wall of the base (11). Two axles (14)(15) each having a bearing (16)(17) mounted thereon are extended from the two ears of the base (11).

The left sidewall (20) defines an axle hole at its center. The axle (14) extends through the left sidewall (20) via the axle hole, hence the left sidewall (20) can be attached to the bearing (16). An inner surface of the left sidewall (20) defines a circular recess, where a transmission ring (40) is formed in the circular recess by injection molding process. However, for the purpose of clear depiction, the transmission ring (40) is still drawn separated from the left sidewall (20) in FIG. 1. Multiple first screw holes (21) are equally defined around and through the left sidewall (20).

The right sidewall (30) has similar structures as the left sidewall (20) but as a mirror image configuration. The right sidewall (30) also defines an axle hole to correspond to the axle (15) so that the bearing (17) can be attached to the right sidewall (30). Multiple stubs (31) are formed and distributed equally on an inner surface of the right sidewall (30). The distal end of each stub (31) abuts against the surface of the transmission ring (40) after the two sidewalls (20)(30) are assembled together. Corresponding to the screw holes (21) of the left sidewall (20), the right sidewall (30) forms multiple second screw holes (32) in the respective positions around the periphery.

The wheel speed detecting device comprises a circular disk (51) that cooperates with a photo counter (52). The disk (51) is mounted on the inner surface of the right sidewall (30), and the photo counter (52) is secured on the base (11). The disk (51) defines a plurality of slots along its whole periphery. As the disk (51) rotates, the light beam emitted from the photo counter (52) will intermittently be interrupted or pass through the slots so that the rotation speed of the wheel is measured according to the frequency variation of the blocked light beam.

The rubber tire (60) has patterns on its tread like normal vehicle tires. A plurality of channels (61) is formed on the inner surface of the rubber tire (60) to retain multiple tubes (62). When assembling the left and right sidewalls (20)(30) to the rubber tire (60), a plurality of bolts (63) is sequentially passed through the first screw holes (21) of the left sidewall (20), the channels (61) and tubes (62) on the rubber tire (60), and the second screw holes (32) of the right sidewall (30). The distal end of each bolt (63) protruding from the right sidewall (30) is further screwed to a nut (64). The rubber tire (60) accordingly surrounds the two assembled sidewalls (20)(30) and is drivingly engaged to the sidewalls (20)(30) by the bolts (63) to effectively transmit power from the motors (12)(13) to the road surface.

The fork assembly is formed by two forks (71)(72) that are respectively mounted on the outer surface of the two assembled sidewalls (20)(30) and connected to the two axles (14)(15) of the base (11). Any power or signal wires can be received inside the forks (71)(72) and electrically connect to the motors (12)(13) and the photo counter (52). Opposed ends of these power and signal wires are connected to a control circuit of the electric wheel. It is to be appreciated that the fork assembly attaches to the base of an appropriate vehicle, and that the axles are secured to the forks (71, 72).

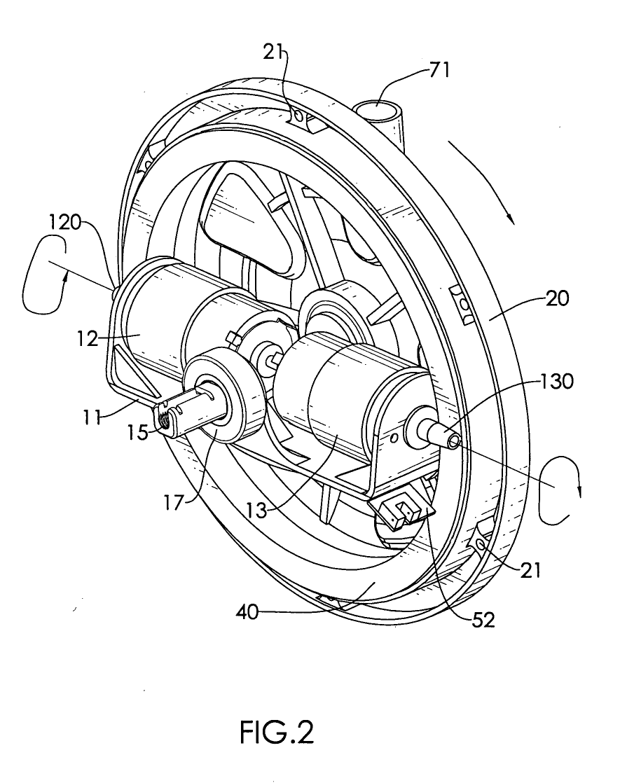

With reference to FIG. 2, the two spindle sleeves (120)(130) are in positions to abut against on the surface of transmission ring (40). After activating the motors (12)(13), the two spindle sleeves (120)(130) start to rotate in opposite directions as indicated by arrow symbols thus driving the transmission ring (20). Since the transmission ring (20) is combined with the two sidewalls (20)(30) as well as the rubber tire (60), the electric wheel can thus have rotating movements relative to the forks (71)(72).

The two spindle sleeves (120)(130) can be further coated with a chromium or chromium alloy layer to enhance the durability thereof. The preferable high durability material for manufacturing the transmission ring (40) can be polyurphene. By properly choosing the material of spindle sleeves (120)(130) and the transmission ring (40), the noise and attrition are able to be effectively kept to a minimum.

In this embodiment, only a pair of motors (12)(13) is applied to drive the transmission ring (40). Depending on the different application requirements, one or more pairs of motors can be further mounted on the base (11) to increase power of the electric wheel. The transmission ratio is dependent on a diameter ratio of the spindle sleeve (120)(130) to the transmission ring (40). Therefore, by changing the size of the wheel, a desired transmission ratio and ability can be achieved.

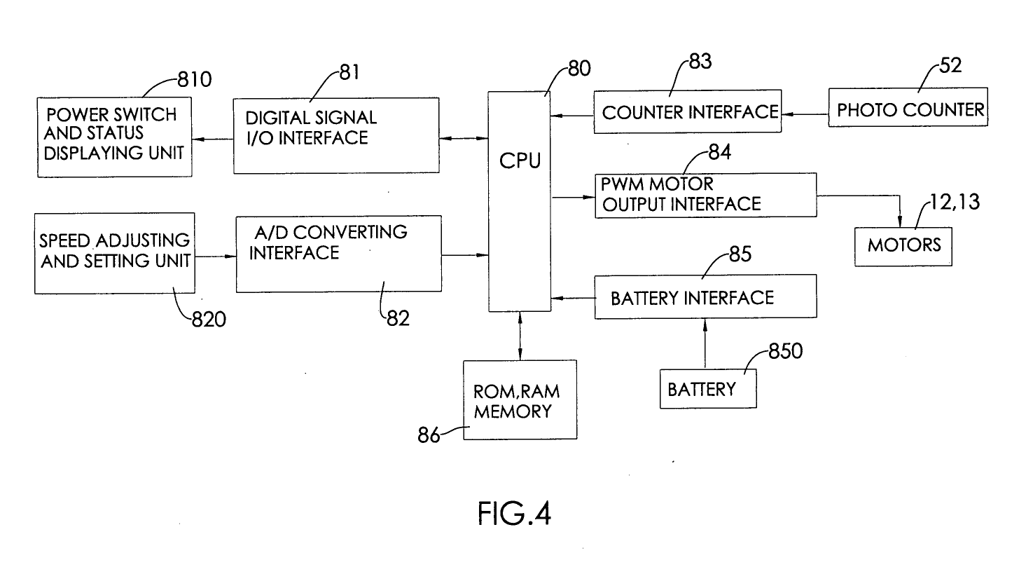

With reference to FIG. 4, a control circuit for the motors (12)(13) in the present invention involves the phase integral differential (PID) and the PWM techniques to adjust the rotation speeds. The control circuit comprises a central processing unit (CPU) (80) connected to a digital signal input/output interface (81), an A/D converting interface (82), a counter interface (83), a PWM motor output interface (84), a memory (86) and a battery interface (85) coupled to a battery (850)

A power switch and status displaying unit (810) is connected to the digital signal input/output interface (81). The unit (810) includes the power switch and indicating elements that can show a status of the remaining electricity of the battery (850). Light emitting elements (LEDs) can serve as the indicating elements. For example, green LEDs represent the electricity condition is normal, yellow means that there is only 40% electricity remaining and the battery (850) should be charged, and red stands for the remaining electricity is lower than 10%. When the red LEDs start to flash, the power supply will be automatically cut off to protect the battery (850) from over-discharging.

A speed adjusting and setting unit (820) is connected to the AID converting interface (82). The speed adjusting and setting unit (820) includes a variable resistor to set a voltage level representing a desired speed. Based on a comparison result of the desired and actual speeds, the CPU (80) determines whether it is necessary to accelerate or decelerate the wheel speed detected at present, wherein the speed is adjusted based on the PID.

The counter interface (83) connects to the photo counter (52) to acquire and supply the presently detected speed to the CPU (80).

The PWM motor output interface (84) connects to the motors (12)(13) and converts speed adjusting commands from the CPU (80) to PWM signals, whereby the speed of the motors (12)(13) is controlled by the PWM signals.

The battery (850) is a rechargeable secondary battery in this embodiment and functions as the power source of the electric wheel.

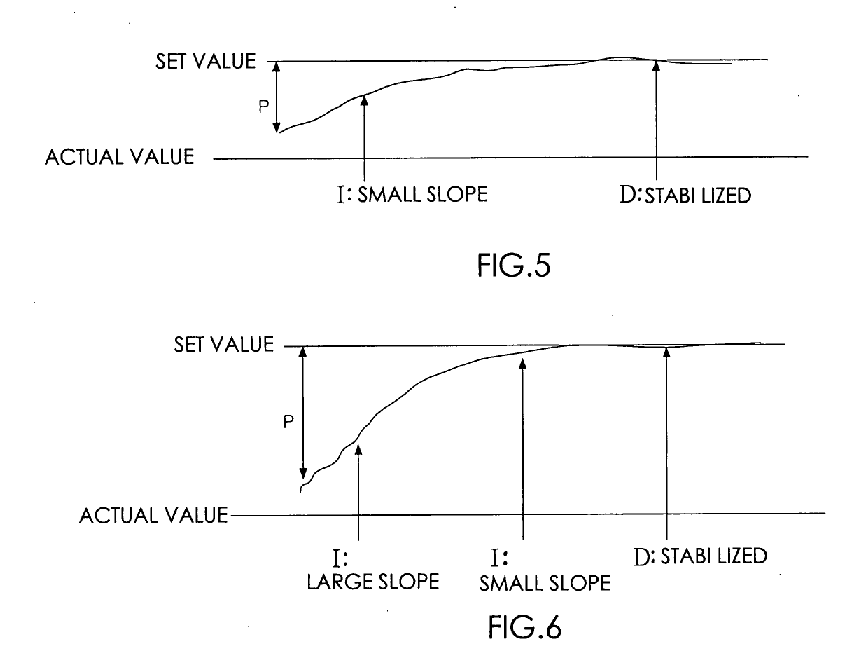

With reference to FIGS. 5 and 6, during the speed adjusting process, the detected actual speed value can be represented by the curve. In the above mentioned PID control theory, “phase” means to calculate a difference quantity between the actual speed value and the desired set speed value, and also to determine an initial value to be output. “Integral” means to gradually adjust the present speed value to the desired set speed value, i.e. to determine the slope of the curve. “Differential” represents that when the actual speed has reached the desired speed, the actual speed should be kept and stabilized.

In FIG. 5, since the difference quantity between the actual and desired speed is not obvious, a small initial value is output to adjust the speed. The variation of the slope is slow and smooth. However, FIG. 5 shows an obvious difference quantity causes a large initial value. Moreover, the slope of the curve has a fast variation firstly, and then gradually becomes smooth.

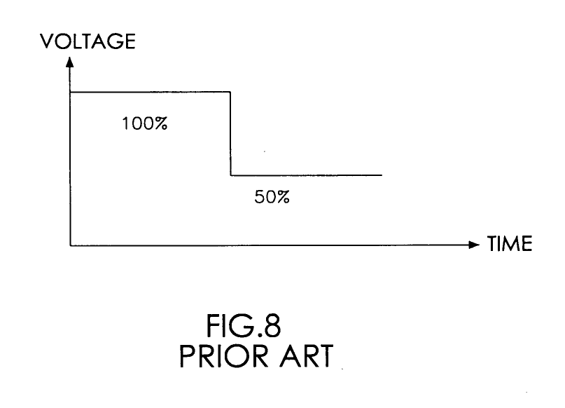

With reference to FIG. 8, the rotation speed is proportional to the power output. If the full power output is 100% and the voltage is 12 volts, a desired 50% power output is achieved by directly reducing 6 volts. However, such a way will result in ineffective power consumption because power transistors have converted the electricity power to heat.

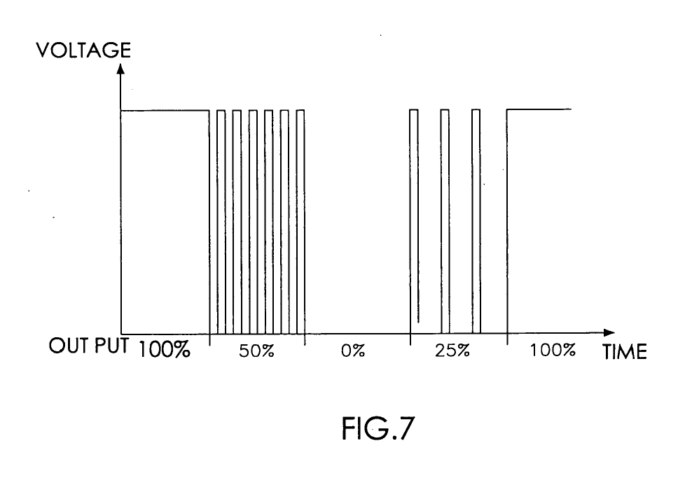

With reference to FIG. 7, to avoid the problem of FIG. 8, the PWM control theory is adopted and involves the method of equally splitting up a duration into several parts. For example, if the 50% power output is required during a certain duration, the duration is divided into parts. Full voltage is output in a half of the parts, while the other half is zero.

The electric wheel of the present invention integrates a transmission assembly as the power source to drive the wheel. As a result, the speed adjustment can be implemented by software control without need for a high precision mechanism. Further, the problem of bulky size and annoying noise also can be mitigated.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electric wheel comprising:
two sidewalls assembled together to retain a transmission assembly therein, wherein a transmission ring is formed on an inner surface of one sidewall and is driven by the transmission assembly to rotate;
a rubber tire surrounding peripheries of the two assembled sidewalls; and
a fork assembly having two hollow forks that are respectively attached to external surfaces of the two sidewalls.

2. The electric wheel as claimed in claim 1 further comprising a wheel speed detecting device mounted in the assembled sidewalls.

3. The electric wheel as claimed in claim 2, the transmission assembly comprising a base and a pair of motors mounted in alignment with each other on the base but rotating in opposite directions, wherein each motor extends a spindle enclosed and protected by a spindle sleeve abutting against the transmission ring.

4. The electric wheel as claimed in 3, wherein the base has a bottom board, two upright walls extending from opposite ends of the bottom board, and two ears each of which projecting from a middle position at an edge of the bottom board, where the spindle sleeve of each of the motors projects through the upright wall of the base, and two axles each having a bearing mounted thereon are extended from the two ears of the base.

5. The electric wheel as claimed in claim 4, wherein the wheel speed detecting device comprises a circular disk mounted on an inner surface of one sidewall, and a photo counter secured on the base, where the disk defines a plurality of slots.

6. The electric wheel as claimed in claim 5, wherein a plurality of bolts is applied to assemble the two sidewalls and the rubber tire together by extending the bolts through the combined sidewalls and the rubber tire.

7. The electric wheel as claimed in claim 6, wherein power and signal wires are received inside the forks and electrically connect to the motors and the photo counter, wherein these power and signal wires are further connected to a control circuit of the electric wheel.

8. The electric wheel as claimed in claim 7, wherein the control circuit comprises:
a CPU connected to a digital signal input/output interface, an A/D converting interface, a counter interface, a PWM output interface, a memory and a battery interface coupled to a battery;
a power switch and status displaying unit connected to the digital signal input/output interface, wherein the unit includes the power switch and indicating elements that show a status of remaining electricity of the battery;
a speed adjusting and setting unit connected to the A/D converting interface, wherein the speed adjusting and setting unit includes a variable resistor to set a voltage level representing a desired speed;
the counter interface connected to the photo counter to acquire and supply a presently detected speed to the CPU; and
the PWM motor output interface connected to the motors and converting speed adjusting commands from the CPU to PWM signals, where the motors are controlled by the PWM signals.
